(19) United States
(12) Patent Application Publication
(10) Pub. No.: US 2024/0269907 A1
(43) Pub. Date: Aug. 15, 2024

(54) METHOD AND TOOL FOR PRODUCING A CONNECTION BETWEEN AT LEAST TWO METAL PARTS

(71) Applicant: Lisa Dräxlmaier GmbH, Vilsbiburg (DE)

(72) Inventors: Peter ESTERBAUER, Ranshofen (AT); Rainer LIEDTKE, Braunau/Inn (AT); Hermann PETERLECHNER, Neukirchen/Enknach (AT); Daniel GREIFENEDER, St. Peter am Hart (AT); Johannes NEUMAYER, Zangberg (DE); Stefan PUESCHEL, Obernberg am Inn (AT)

(73) Assignee: Lisa Dräxlmaier GmbH, Vilsbiburg (DE)

(21) Appl. No.: 18/644,892

(22) Filed: Apr. 24, 2024

Related U.S. Application Data
(63) Continuation of application No. PCT/EP2022/081094, filed on Nov. 8, 2022.

(30) Foreign Application Priority Data
Nov. 22, 2021 (DE) 102021130410.5

(51) Int. Cl. B29C 45/14; B29C 45/16; B29C 45/76; B29K 705/00; B29L 31/34

(52) U.S. Cl. CPC B29C 45/14065; B29C 45/14467; B29C 45/1671; B29C 45/76; B29C 2045/1454; B29C 2945/76006; B29C 2945/7609; B29C 2945/76294; B29C 2945/76471; B29K 2705/00; B29L 2031/3493

(57) ABSTRACT

An injection molding tool and method are used to create a connection between at least two metal parts. The metal parts are inserted into the injection molding tool. Using a clinching device of the injection molding tool, the metal parts are mechanically connected to one another by clinching and are encapsulated with a plastic material using an extruder connected to the injection molding tool so as to, at least partially, enclose the metal parts with overmolding or casting.

### CROSS-REFERENCE TO RELATED APPLICATIONS

This application is a continuation of International Application No. PCT/EP2022/081094, filed on Nov. 8, 2022, which claims priority to and the benefit of DE 10 2021 130 410.5 filed on Nov. 22, 2021. The disclosures of the above applications are incorporated herein by reference.

### FIELD

The present disclosure relates to a method for establishing a connection between at least two metal parts, as well as a corresponding tool.

### BACKGROUND

The statements in this section merely provide background information related to the present disclosure and may not constitute prior art.

The present disclosure described below primarily concerns busbars for electric vehicles.

A busbar is a solid strip of sheet metal used to provide a large wire cross-section to enable transmission of high current flows. A busbar can, for example, be made of aluminum or copper.

The busbar can, for example, be used to electrically connect battery modules of an electric vehicle traction battery. The busbar can connect battery module connection terminals to one another.

The busbar can be made from one metal piece. For example, the busbar can be cut out of a single sheet of metal. The bus bar can be completely cut out of a single sheet of metal or punched and molded. In the case of busbars with complex geometries, considerable waste can occur.

Alternatively, the busbar can be assembled from several smaller individual parts. Individual parts can be connected to one another, for example, through clinching. Clinching entails aligning at least two of the individual parts in an assembly device using clinching pliers.

The busbar has an electrically conductive surface and has an electrically insulating housing or an electrically insulating casing to provide protection against contact (shock).

The busbar can be inserted into the housing and the housing can then be closed with a cover.

Alternatively, the busbar can be inserted into an injection molding tool and overmolded with the cover.

### SUMMARY

This section provides a general summary of the disclosure and is not a comprehensive disclosure of its full scope or all of its features.

The present disclosure provides an improved method for producing a connection between at least two metal parts, as well as a corresponding improved tool, using means that are as structurally simple as possible. Such an improvement may, for example, relate to an accelerated manufacturing process and the use of less tools.

In the approach presented here, a clinching device with at least one punch and one die is integrated into an injection molding tool. The clinching device can also have several punches and dies. The punch can, for example, be positioned in one half of the injection molding tool, while the die is positioned in the other half of the injection molding tool. The punch and die can then move in a closing direction of the injection molding tool. Likewise, the punch and die can be positioned in the same tool half and move transverse to the closing direction. The clinching device can be operated by the injection molding tool actuators. For example, the injection molding tool transverse pulls can drive the clinching device directly or via deflection devices.

The clinching device can be operated when the injection molding tool is closed. By guiding the injection molding tool, the components of the clinching device arranged in the different tool halves can be aligned with one another.

A method for producing a connection between at least two metal parts is presented wherein the metal parts are inserted into an injection molding tool, the metal parts are mechanically connected to one another by clinching using an injection molding tool clinching device and are encapsulated with plastic using an extruder connected to the injection molding tool so as to at least partially cover the metal parts via encapsulation.

Moreover, the present disclosure presents an injection molding tool to create a connection between at least two metal parts, where the injection molding tool has a clinching device to mechanically connect the metal parts within the injection molding tool and at least one mold cavity to form a mold around the connected metal parts.

An injection molding tool can serve as a tool for the primary molding of at least one plastic component. The injection molding tool can have at least one mold cavity. The mold cavity can be referred to as the injection molding tool cavity. The mold cavity can have the desired contour of the plastic component to be produced. The mold cavity can be filled with plasticized, deformable plastic material. When filled, the plastic material can take on or mold the contour of the mold cavity and solidify into the plastic component in the mold cavity. In particular, the plastic material can be a thermoplastic that solidifies when cooled within the mold cavity. The injection molding tool can be cooled for this purpose. The plasticized synthetic material can be provided at high pressure by an extruder of an injection molding machine in liquid or fluid form.

To facilitate the removal of the plastic component from the mold cavity, the injection molding tool can be divided into at least two tool halves. The tool halves can be referred to as the nozzle side and the ejector side. The mold cavity can be located in a partition plane of the injection molding tool. The mold cavity can have draft slopes that run in the direction of the partition plane. The nozzle side can be coupled to the extruder. The ejector side can be coupled to a locking mechanism of the injection molding machine. The ejector side can have ejectors that are designed to eject the plastic component from the mold cavity when the tool halves are pulled apart.

Inserts to be overmolded can be inserted into the open injection molding tool. The injection molding tool can have corresponding receptacles designed for this purpose. The receptacles can align and hold the inserts until the tool halves are closed. The mold cavity can then have a contour of an encapsulation of the inserts. The inserts in the receptacles can rest on and be directly held by the injection molding tool. This means that the receptacles can be arranged outside the mold cavity. The receptacles are generally not shaped by the plastic material.

The inserts in particular can be metal parts. The metal parts can be metal strips. The inserts can, for example, be individual parts of a busbar composed of several individual parts. The inserts can also have different functions. For example, an insert can have a melting area that acts as a fuse.

Clinching can be a mechanical joining process in which two or more stacked metal parts made of sheet metal can be connected to one another in a form-fitting and non-positive manner at one or more clinching points. Clinching can be referred to as clinching or toxing. To create a clinching point, a punch and a concave die can be pressed onto the stacked metal parts from opposite sides to perform a working stroke. The punch can be smaller at the tip than the die. This allows the punch to strike into the die and locally deform the metal parts in the die until a metal surface part facing away from the die rests on the bottom of the die. Then, at the end of the working stroke, the punch can be pressed forcefully against the die so that material from the metal parts trapped in a gap between the punch and the die flows sideways out of the gap, and thus forms a particularly annular undercut of the clinching point.

In the approach presented here, a clinching device is integrated into the injection molding tool. The clinching device can have at least one pair of tools consisting of a punch and a die. The clinching device can also have several pairs of tools, especially those that are operated simultaneously. The punch and die of a tool pair can be positioned in different tool halves of the injection molding tool. Alternatively, the punch and die of a tool pair can also be positioned in the same half of the tool. The metal parts to be joined can be composed of the insert parts of the injection molding tool. The clinching device can be propelled or operated by the actuators of the injection molding tool. Multiple pairs of tools can be operated at the same time. The clinching device can be operated after the injection molding tool has been closed.

The mold cavity can be filled with the plastic material, especially after producing at least one clinching point. This allows the plasticized plastic material to flow around and embed the clinching point. Alternatively, the metal parts can be overmolded before clinching. During a first injection molding process, an area around the future clinching point(s) can be left out in the encapsulation. After overmolding, the metal parts can be connected to each other. After they have been connected, the recesses with at least one clinching point can be filled with plastic material in an additional injection molding process.

The metal parts can be inserted into the opened injection mold using a robot. After the overmolding, the overmolded metal parts can be removed from the injection molding tool by the robot or a second robot. Alternatively, the overmolded metal parts can be ejected from the opened injection molding tool.

The metal parts can be positioned using a positioning device of the injection molding tool before and during the overmolding process. Recesses left in the encapsulation by the positioning device can be filled with plastic material.

A positioning device can be designed to inhibit movement of the metal parts due to the plasticized plastic material flowing into the mold cavity. The positioning device can be arranged at least partially in the mold cavity. Recesses in the overmolding can occur where the positioning device contacts the metal parts within the mold cavity to position them. The fluid plastic material can at least partially mold the positioning device. For example, the positioning device can have at least one pair of clamping jaws that are aligned with one another and pressed onto the metal parts from opposite directions. The pair of clamping jaws can clamp the metal parts before and during overmolding. The clamping jaws can be arranged in different tool halves of the injection molding tool and can be pressed against the metal parts after or during closing of the injection molding tool. Likewise, the clamping jaws can be arranged in the same tool half and, for example, can be actively pressed against the metal parts in order to secure them in the tool half as the metal parts are inserted into the tool half. The positioning device can alternatively or additionally have stops for aligning the metal parts in the mold cavity. The metal parts can be placed against the stops when inserted. The stops can inhibit the metal parts from moving during overmolding. The positioning device can also have a locking device to lock the metal parts into a tool half. The metal parts can be pressed into the locking device when inserted and locked into the locking device. Continuous contact protection for the metal parts can be achieved by filling the recesses. A separate housing may, therefore, be omitted.

The positioning device can be lifted off the metal parts if the metal parts are set by the plastic material that has already flowed into the mold cavity. The recesses left in the overmolding by the positioning device can be filled with additional plastic material. The positioning device can be controllable or controlled when the injection molding tool is closed. The recesses can thus be filled during the same injection molding process in which the overmolding is produced. For example, to provide additional plastic material, pressure can be added using the extruder when the positioning device is being or has been retracted.

The clinching device can be arranged in a separate clinching receptacle of the injection molding tool. The mold cavity can be arranged next to the clinching joint receptacle in the injection molding tool. The metal parts can be inserted in the clinching receptacle and connected using the clinching device. The injection molding tool can be opened after clinching. The connected metal parts can be relocated to the injection molding tool's mold cavity for overmolding. The injection molding tool can be multi-stage and opened and closed multiple times to produce a finished part. The injection molding tool can be closed during clinching. Using the robot, the connected metal parts can be relocated to the mold cavity. The clinching receptacle can be separate from the mold cavity. This can inhibit contamination of the clinching device by fluid plastic material. Both the clinching device and the mold cavity can thus be less complex.

The connected metal parts can be positioned in the mold cavity by the positioning device. The injection molding tool can be reopened after overmolding and the metal parts set by the overmolding can be relocated to another mold cavity of the injection molding tool to fill the recesses. The recesses can be filled with additional plastic material injected into the additional mold cavity. By adding an additional mold cavity and carrying out several successive steps to produce a finished part, the individual mold cavities can be designed without actively moving elements. The positioning device can permanently stay in one mold cavity and therefore actuators may be omitted. The additional mold cavity may omit a positioning device since the overmolding/cast from the first mold cavity provides a positive fit and desired positioning of the metal parts in the additional mold cavity. The robot can move the overmolded metal parts from mold cavity to mold cavity.

Alternatively, the clinching device can be inserted into the mold cavity and retracted from the mold cavity. The injection molding tool can have sliders to release and close any openings in the mold cavity that are present for clinching receptacle. The clinching device can be retracted from the mold cavity after clinching and the openings can be closed by the sliders before overmolding. The clinching device can be moved by more than its working stroke to produce the clinching point or clinching points. The sliders can be moved transversely to a direction of the clinching device. The sliders can reproduce a portion of the contour of the mold cavity. The sliders can protect the clinching device from the plastic material. Thanks to the displaceable clinching device, all work steps for producing the finished part can be carried out within a mold cavity.

The quality of a clinching can be monitored using an injection molding tool pressure sensor. The injection molding tool can have a sensor system specifically designed to monitor clinching. A pressure sensor can, at the very least, detect the maximum pressure reached when producing a clinching point. The pressure sensor can also detect any pressure progression during clinching. Clinching can be controlled using pressure. Clinching can, for example, be stopped when a set target pressure is reached. The pressure can be recorded during each clinching process. If the maximum pressure falls within a specific tolerance range, the clinching point can be recorded as OK (i.e., acceptable). If the pressure falls outside the tolerance range, the clinching point may be considered defective and the part may be discarded. Quality can alternatively or additionally be monitored using an injection molding tool displacement sensor. A path sensor can record a path or the working stroke of the clinching device while producing a clinching point. Clinching can be controlled using this path. Clinching can, for example, be canceled once a planned target stroke is reached. The working stroke can be recorded for each clinching process. If the working stroke falls within a set tolerance range, the clinching point can be documented as OK. If the working stroke falls outside the tolerance range, the clinching point can be classified as faulty and the part can be discarded.

The clinching device can be monitored using an injection molding tool structure-borne sound sensor. The injection molding tool can have a sensor system specifically designed for monitoring the clinching device and/or the injection molding tool. A structure-borne sound sensor can detect as well as capture and record noise from the injection molding tool, the clinching device and/or the injection molding machine during the insertion of the metal parts, closing of the injection molding tool, clinching of the metal parts, overmolding of the metal parts, opening of the injection molding tool and/or removal of the finished part from the injection molding tool. Using the recorded structure-borne noise or noises from the wear on the injection molding tool and/or the clinching device can be detected over time based on changes noted in the structure-borne noise. Monitoring is possible using machine learning. For example, it is possible to make a prediction regarding the remaining useful life of an injection molding tool and/or clinching device. In order to extend the useful life of the device, a schedule for maintenance can be established to, for example, replace components and/or lubricate components based on structure-borne noise.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a schematic representation of one form of an injection molding tool according to the present disclosure;

FIG. 2A shows a schematic representation of a step in a process to join at least two metal parts according to the present disclosure;

FIG. 2B shows a schematic representation of another step in the process to join at least two metal parts according to the present disclosure; and

FIG. 2C shows a schematic representation of another step in the process to join at least two metal parts according to the present disclosure.

The figures or illustrations are schematic representations that only serve to explain the present disclosure. Elements that are the same or that have the same effect are consistently provided with the same reference numbers.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

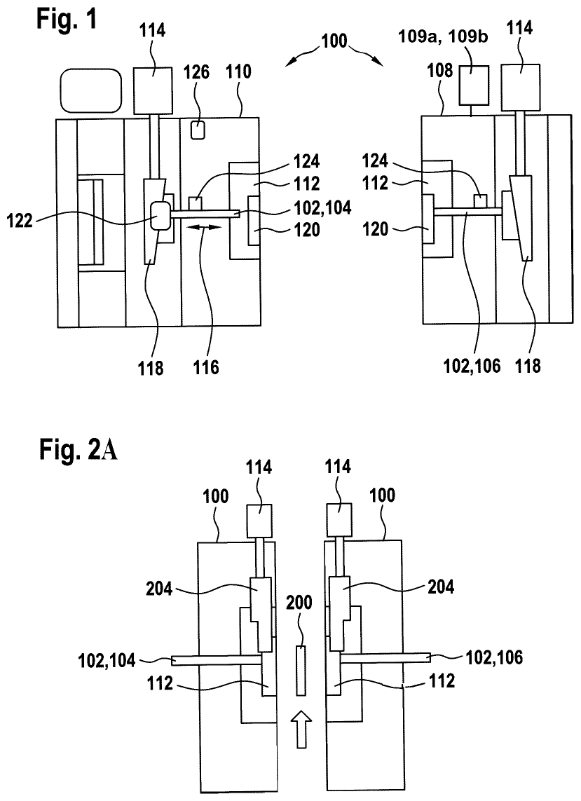

FIG. 1 is an illustration of an injection molding tool 100. Injection molding tool 100 has an integrated clinching device 102 for clinching, joining or toxing. Clinching device 102 has at least one punch 104 integrated into injection molding tool 100 and a die 106 that is integrated into injection molding tool 100. Punch 104 and die 106 form a pair of tools integrated into clinching device 102 that are used to produce a single clinching point between at least two metal parts. Clinching device 102 has one pair of tools for each intended clinching point.

The die 106 is integrated here into a nozzle side 108 of injection molding tool 100. The punch 104 is integrated into an ejector side 110 of the injection molding tool 100 and aligned with die 106. The nozzle side 108 and the ejector side 110 are tool halves of the injection molding tool 100. During operation, nozzle side 108 is connected to an extruder 109a of an injection molding machine 109b (only shown in FIG. 1 for ease of illustration). The extruder 109a provides plasticized plastic material for filling mold cavity 112 of the injection molding tool 100. When ready for operation, ejector side 110 is connected to a closing mechanism of the injection molding machine and is moved linearly by the closing mechanism to open and close the injection molding tool 100. To provide that the tool halves are aligned while closing, the injection molding tool 100 has guide columns (not shown here) to direct the closing movement. The guide columns also join the clinching device 102 components together.

The clinching device 102 is driven by at least one actuator 114 of injection molding tool 100. Here, the actuator 114 is designed as a hydraulic cylinder. Actuator 114 moves the punch 104 onto a working stroke 116 to produce the clinching point. The working stroke 116 can measure approximately 15 millimeters. The working stroke 116 is aligned here transversely in the working direction of actuator 114. The actuator 114 initiates a transverse pull of the injection molding tool 100. To redirect the working direction toward working stroke 116, a deflection device 118 is positioned between the actuator 114 and the punch 104. In this instance, the deflection device 118 is designed as an oblique wedge that serves as a backdrop to the injection molding tool 100 connected to the transverse pull.

One example shows that the ends of punch 104 and die 106 open into a separate clinching receptacle 120 of the injection molding tool 100. There is space separating the clinching receptacle 120 from the mold cavity 112. A robot or handling device inserts the metal parts to be connected into the clinching receptacle 120 and connects them by clinching at least one joining point. To produce at least one joining point, the nozzle side 108 and the ejector side 110 of the injection molding tool 100 are moved together. The punch 104 and die 106 are placed onto the metal parts. Injection molding tool 100 closes around the inserted metal parts. Actuator 114 then moves punch 104 around the working stroke 116 and the joining point is stamped onto the metal parts. Injection molding tool 100 is then opened and the nozzle side 108 and the ejector side 110 are moved apart again. The robot then removes the connected metal parts from the clinching receptacle 120 and places the connected metal parts directly into the mold cavity 112.

One example shows that the ends of the punch 104 and the die 106 open into the mold cavity 112. The metal parts are inserted into the mold cavity 112 for clinching and the nozzle side 108 and the ejector side 110 are moved together after which the injection molding tool 100 is closed around the inserted metal parts. The punch 104 and the die 106 are then moved and fed into the mold cavity 112 until the punch 104 and the die 106 are positioned on the metal parts. For this purpose, the die 106 is also driven by the actuator 114 of the injection molding tool 100. Once the punch 104 and the die 106 rest on the metal parts, the actuator 114 actuates the punch 104 using the working stroke, and the joining point is stamped into the metal parts. After the clinching, the punch 104 and the die 106 are retracted from the mold cavity 112 by the actuators 114.

After the punch 104 and the die 106 have been retracted, the connected metal parts in mold cavity 112 are overmolded with plastic material. Injection molding tool 100 is then opened and the nozzle side 108 and the ejector side 110 are pulled apart. The robot then removes the overmolded metal parts from the mold cavity 112.

One example shows that the injection molding tool 100 has a sensor system for monitoring the clinching process. The sensor system includes at least one pressure sensor 122 or force sensor 122 and/or a displacement sensor 124. Pressure sensor 122 is arranged in a force flow between the actuator 114 and the punch 104 or the die 106. The pressure sensor 122 detects the pressure created during the working stroke 116, or the resulting force when producing the joining point. The displacement sensor 124 detects the working stroke 116. If the pressure falls outside a tolerance range, the joining point may be recognized as faulty.

In another example the injection molding tool 100 has a sensor system for monitoring the clinching device 102. The sensor system includes at least one structure-borne sound sensor 126. The structure-borne sound sensor 126 detects noise(s) during the assembly. The structure-borne sound sensor can also detect noise(s) occurring before and/or after clinching. For example, a squeaking noise could signal the desire for lubrication of the clinching device 102.

Noise can be evaluated over the long term in order to be able to recognize changes in a timely manner. In one form, the noises can be evaluated using machine learning and artificial intelligence algorithms to monitor the clinching device 102.

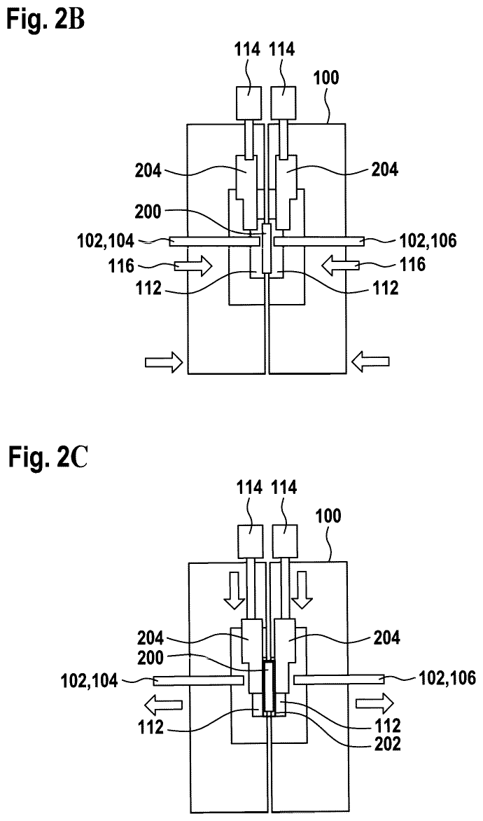

FIGS. 2A to 2C illustrate a connection process for at least two metal parts 200 as an example. The metal parts 200 are joined together in an injection molding tool 100 by clinching and then are encapsulated in the injection molding tool 100 by plastic overmolding also referred to herein as casting 202.

FIG. 2A shows the opened injection molding tool 100 and the metal parts 200 to be inserted into the mold cavity 112 of injection molding tool 100.

In FIG. 2B, the injection molding tool 100 is closed and the metal parts 200 are clamped between the punch 104 and the die 106 of the clinching device 102 by moving the punch 104 and the die 106 into mold cavity 112 until they are resting on the metal parts 200. The joining point is then created by the punch via the working stroke 116.

In FIG. 2C, the punch 104 and the die 106 are retracted from the mold cavity 112. To close mold cavity 112, the sliders 204 are moved in front of the recesses for the clinching device 102. The sliders 204 form a section of the contour of the casting 202. Sliders 204 are driven by actuators 114 of injection molding tool 100. The actuators 114 are hydraulic cylinders. After the sliders 204 close the recesses, the plastic material is injected into mold cavity 112, and encases the connected metal parts 200 and takes on the contour of the mold cavity 112.

The injection molding tool 100 is then reopened and the metal parts 200 covered by the overmold/casting 202 are removed from mold cavity 112.

In other words, clinching or toxing in the injection molding tool 100 is shown. The two processes of clinching and injection molding have so far taken place independent of each other and each has its own production environment (injection molding machine, assembly system, toxing tongs, etc.). A combination of the two individual processes clinching (toxing) and injection molding into one manufacturing process is presented here. The injection molding tool 100 is also used as a toxing tool. The two processes take place one after the other. First the toxing takes place and then the injection takes place. This allows for more freedom in component design, cost reduction, waste improvement regarding sheet metal parts, a reduction in investment costs and/or a reduction of production surfaces.

In one example of the injection molding tool 100 presented, the toxing unit die 106 is integrated into the nozzle side 108. The toxing unit punch 104 is integrated into the ejector side 110. Hydraulic sliders that drive the toxing unit are positioned on both the nozzle side 108 and the ejector side 110.

At the start, the injection molding tool 100 is open and the inserts or metal parts 200 are placed in the injection molding tool 100. The injection molding tool 100 then closes. The toxing unit die 106 on the nozzle side 108 then advances to the toxing position using a hydraulic core pull. The toxing unit punch 104 located on the ejector side 110 advances to the toxing position using a hydraulic core pull. The toxing process now takes place. The punch 104 then moves back to an injection position using the hydraulic core pull. The die 106 also moves back to the injection position using the hydraulic core pull. The sliders 204 on the nozzle side 108 and the ejector side 110 then move into the spraying position hydraulically so as to seal off the toxing unit from the mold cavity 112. Plastic is then injected into the mold cavity 112. The injection molding tool 100 is opened and the finished component is removed from the mold.

The entire toxing and spraying process as well as quality testing are monitored and controlled. The toxing values are monitored using a pressure sensor 122. Wear is checked using a structure-borne sound sensor 126 located on the injection molding tool 100.

Since the devices and methods described in detail above are examples, modification is possible to a wide extent in the usual way by an individual who is skilled in the art, without departing from the scope of the present disclosure. In particular, the mechanical arrangements and size relationships of the individual elements to one another are merely examples.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for producing a connection between at least two metal parts, the method comprising:
inserting the at least two metal parts into an injection molding tool;
mechanically clinching, via a clinching device of the injection molding tool, the at least two metal parts such that the at least two metal parts are connected to each other; and
encapsulating, via an extruder connected to the injection molding tool, the at least two metal parts with a plastic material to at least partially envelop the at least two metal parts with a casting.

2. The method according to claim 1, further comprising:
positioning, via a positioning device of the injection molding tool, the at least two metal parts before and during the encapsulating of the at least two metal parts; and
filling at least one recess left in the casting by the positioning device with the plastic material.

3. The method according to claim 2, further comprising:
lifting the positioning device off the at least two metal parts when the at least two metal parts are fixed by the plastic material.

4. The method according to claim 1, wherein inserting the at least two metal parts into the injection molding tool includes inserting the at least two metal parts into a clinching receptacle of the injection molding tool, wherein the method further comprises:
opening the injection molding tool after mechanically clinching the at least two metal parts; and
relocating the connected at least two metal part to a mold cavity of the injection molding tool for casting.

5. The method according to claim 4, further comprising:
positioning, via a positioning device of the injection molding tool, the at least two metal parts before and during the encapsulating of the at least two metal parts;
reopening the injection molding tool after the at least two metal parts are at least partially enveloped with the casting;
relocating the at least two metal parts that were at least partially enveloped with the casting to a second mold cavity of the injection molding tool; and
filling at least one recess left in the casting by the positioning device by injecting additional plastic material into the second mold cavity,
wherein the connected at least two metal parts are positioned in the mold cavity by the positioning device of the injection molding tool.

6. The method according to claim 1, further comprising:
retracting the clinching device from a mold cavity of the injection molding tool after clinching the at least two metal parts; and
moving a slider of the injection molding tool into openings in the mold cavity that are present for the clinching device before the casting of the at least two metal parts.

7. The method according to claim 1, further comprising monitoring via a pressure sensor of the injection molding tool, a quality of the clinching of the at least two metal parts.

8. The method according to claim 7, further comprising monitoring via a displacement sensor of the injection molding tool, a quality of the clinching of the at least two metal parts.

9. The method according to claim 1, further comprising monitoring via a displacement sensor of the injection molding tool, a quality of the clinching of the at least two metal parts.

10. The method according to claim 1, further comprising monitoring, via a structure-borne sound sensor of the injection molding tool, the clinching device.

11. An injection molding tool for producing a connection between at least two metal parts, the injection molding tool comprising:
an assembly device configured to mechanically connect the at least two metal parts within the injection molding tool; and
at least one mold cavity configured to form an overmolding around the connected at least two metal parts.

12. The injection molding tool according to claim 11, wherein the assembly device is configured to be inserted into the at least one mold cavity and retracted from the at least one mold cavity, the injection molding tool further includes at least one slider configured to release and close the assembly device, wherein the injection molding tool defines existing openings in the at least one mold cavity.

13. The injection molding tool according to claim 11, wherein the assembly device is positioned in a clinching joining receptacle of the injection molding tool, the at least one mold cavity is positioned adjacent to the clinching receptacle in the injection molding tool.
